(19) United States
(12) Patent Application Publication
(10) Pub. No.: US 2021/0187793 A1
(43) Pub. Date: Jun. 24, 2021

(54) Method Of Forming A Mold Tool For Poured Foam Parts

(71) Applicant: RCO ENGINEERING INC, Roseville, MI (US)

(72) Inventors: Donald Gearhart, Macomb, MI (US); Brandon Rudzewicz, Royal Oak, MI (US); Tyler Kipke, Orion Twp, MI (US)

(21) Appl. No.: 17/127,349

(22) Filed: Dec. 18, 2020

Related U.S. Application Data
(60) Provisional application No. 62/979,757, filed on Feb. 21, 2020.
(60) Provisional application No. 62/951,137, filed on Dec. 20, 2019.

(51) Int. Cl. B29C 33/38; B29C 64/188; B33Y 10/00; B33Y 70/00; B33Y 80/00

(52) U.S. Cl. CPC B29C 33/3842; B29C 33/3807; B29C 64/188; B29K 2475/00; B33Y 70/00; B33Y 80/00; B33Y 10/00

(57) ABSTRACT

A method of manufacturing a mold tool for manufacturing poured foam parts wherein the mold tool includes lower and upper molds and the method includes 3D printing a composite mold to form a mold cavity for forming the poured foam parts. The 3D printing of lower and/or upper molds decreases the time and expense required for producing a mold tool whether for prototype or full production foam parts.

### CROSS REFERENCE TO RELATED APPLICATIONS

This application claims priority of U.S. Provisional Patent Application No. 62/979,757, filed Dec. 18, 2020, and U.S. Provisional Patent Application No. 62/951,137, filed Dec. 20, 2020, the disclosures of which are incorporated herein by reference in their entirety.

### BACKGROUND OF THE INVENTION

### 1. Field of the Invention

The present invention relates to a method of forming a mold tool for manufacturing poured foam parts.

### 2. Description of Related Art

It is generally known to manufacture a foam part by pouring liquid polyurethane foam into a mold tool. The mold tool comprises a bottom mold forming a cavity defining the desired shape of the foam part and a top lid for closing the mold. The liquid polyurethane foam is poured into the cavity of the bottom mold and the top lid is closed over the mold. The liquid polyurethane foam is allowed to expand in the mold tool until the foam sets to the desired shape as defined by the cavity of the mold. The mold tool is typically formed by casting, machining, and assembling various components such as heating/cooling lines, hinges, and vents to make the bottom mold and top lid.

However, the casting and machining of the mold tools is expensive and time consuming. The casting of mold tools is thus often not practical for producing prototype parts or when mold tools are needed on a fast timeline for production. Also, each foam part requires a unique mold tool to form the specific and desired shape of the foam part. Thus, it is also expensive to cast a new mold tool for every new foam part or each change in an existing foam part.

Therefore, it is desirable to provide a method of manufacturing a mold tool for manufacturing poured foam parts wherein the method includes 3D printing a composite mold tool to form a mold cavity for forming the poured foam parts. The 3D printing significantly decreases the time and expense required for producing a mold tool whether for prototype or full production foam parts.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a mold tool for use in manufacturing a poured foam part in the closed position;

FIG. 2 is a fragmentary perspective view of the mold tool in an open position;

FIG. 3 is a front perspective view of the mold tool in the open position;

FIG. 4 is a side perspective view of the mold tool in the open position;

FIG. 5A is an example of the 3D printing data, parameters and process for forming the mold tool;

FIG. 5B is a cross-sectional view of the 3D printed lower mold of the mold tool;

FIGS. 6A-6E are top views of the various stages or layers of the 3D printed lower mold;

FIGS. 7A-7E are side view of the various stages or layers of the 3D printed lower mold;

FIG. 8 is a plan view of a first embodiment of an infill pattern used in the embodiment of FIGS. 1-7 showing a 3D crisscross lattice pattern for the infill;

FIG. 9A is a plan view of an alternate second embodiment of an infill pattern showing a 3D Gyroid lattice pattern for the infill;

FIG. 9B is a perspective view of a mold body with a gyroid pattern for the infill;

FIG. 10 is a perspective view of a second embodiment of a mold tool for use in manufacturing a poured foam part in the closed position;

FIG. 11 is a front perspective view of the mold tool of FIG. 10 in an open position;

FIG. 12 is a front perspective view of the mold tool in the closed position;

FIG. 13 is a front perspective view of a third embodiment of a mold tool for use in manufacturing a poured foam part in the closed position;

FIG. 14 is a rear perspective view of a top lid for the mold tool of FIG. 13 and an upper mold insert thereof;

FIG. 15 is a rear perspective view of the mold tool in a closed position showing an upper heating unit therefor;

FIG. 16 is a top view of the upper heating unit;

FIG. 17 is a partial front perspective of the mold tool in the open position showing the lower mold with a lower mold insert;

FIG. 18 is a bottom perspective view of a bottom mold panel with the bottom mold insert and support panel therefor;

FIG. 19 is a bottom view a lower heating unit;

FIG. 20 is an example of the 3D printing data, parameters and process for forming the mold tool with a gyroid pattern;

FIGS. 21A-21B are top views of the various stages or layers of the 3D printed upper mold body of the embodiment of FIG. 10; and

FIGS. 21C-21D are top views of the various stages or layers of the 3D printed lower mold body of FIG. 10.

### DETAILED DESCRIPTION OF THE PREFERRED EMBODIMENT

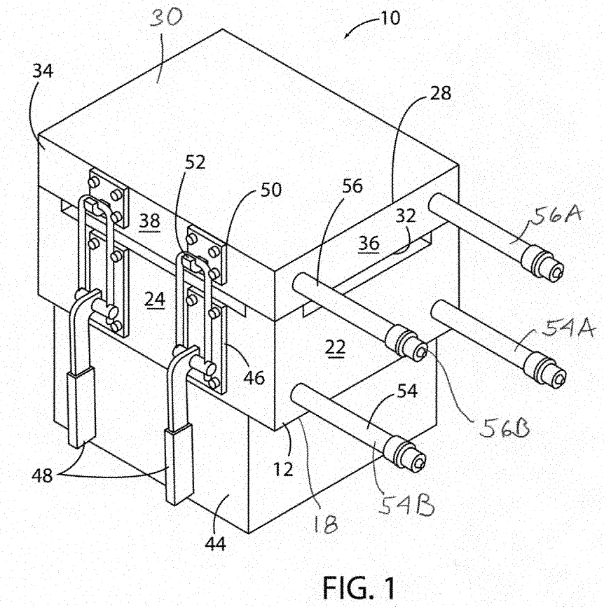

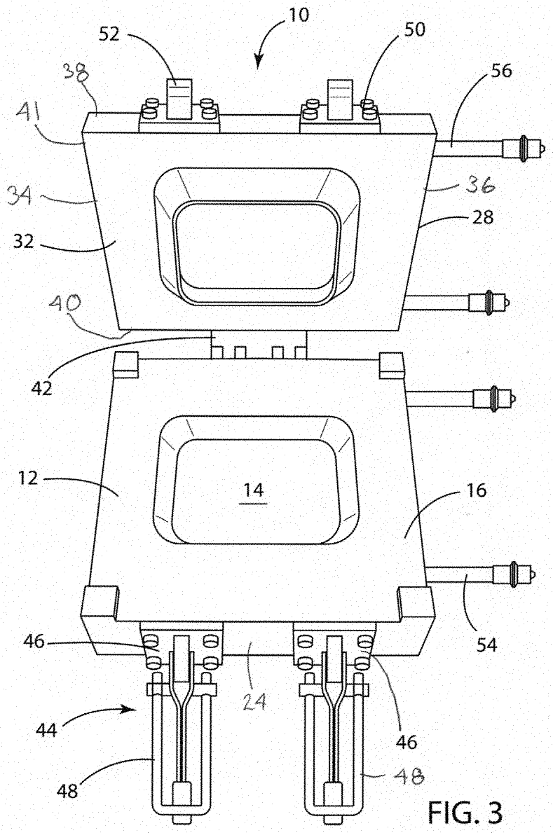

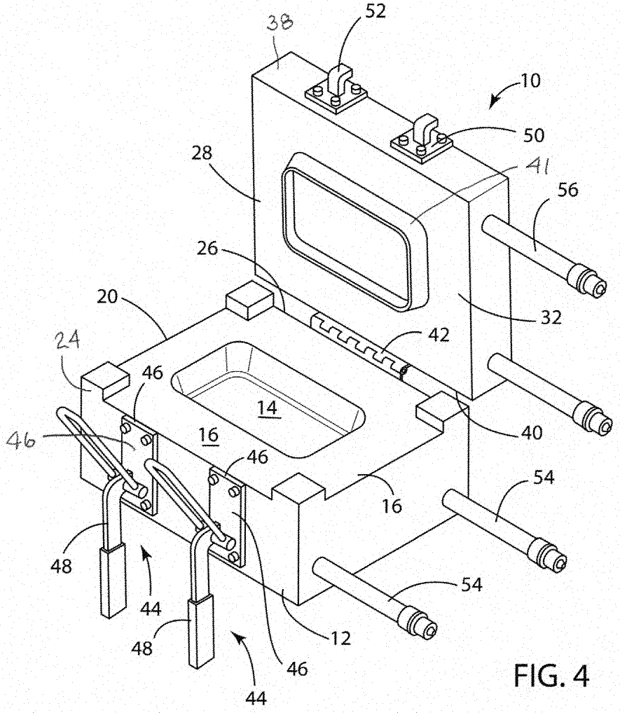

Referring to the Figures, wherein like numerals indicate like or corresponding parts throughout the several views, a mold tool for use in manufacturing a poured foam part according to a first embodiment of the invention is shown at 10 in FIGS. 1-4. The poured foam part manufactured with use of the mold tool 10 and the remaining embodiments disclosed herein may be any type of part such as a seat cushion, seat back, head restraint, or any other polyurethane foam part.

The mold tool 10 comprises a lower mold 12 defining a recessed mold cavity 14 extending between a top mold surface 16 and a bottom mold surface 18. The mold cavity 14 may be formed as an upward opening bowl for receiving poured foam during the mold operation. The lower mold 12 also includes spaced apart side walls 20, 22 extending between a front wall 24 and a back wall 26 and surrounding the mold cavity 14.

The mold tool 10 further comprises an upper mold 28, or lid, pivotally coupled to the lower mold 12 for closing the mold cavity 14. The upper mold 28 similarly includes a top surface 30, a bottom surface 32 for engaging the top surface 16 of the lower mold 12 and closing the mold cavity 14, and spaced apart side walls 34, 36 extending between a front wall 38 and back wall 40. A mold lid 41 is formed in the bottom mold surface 32, preferably projecting therefrom, for mating with the mold cavity 14 although the mold lid 41 may also have at least a portion recessed into the bottom mold surface 32.

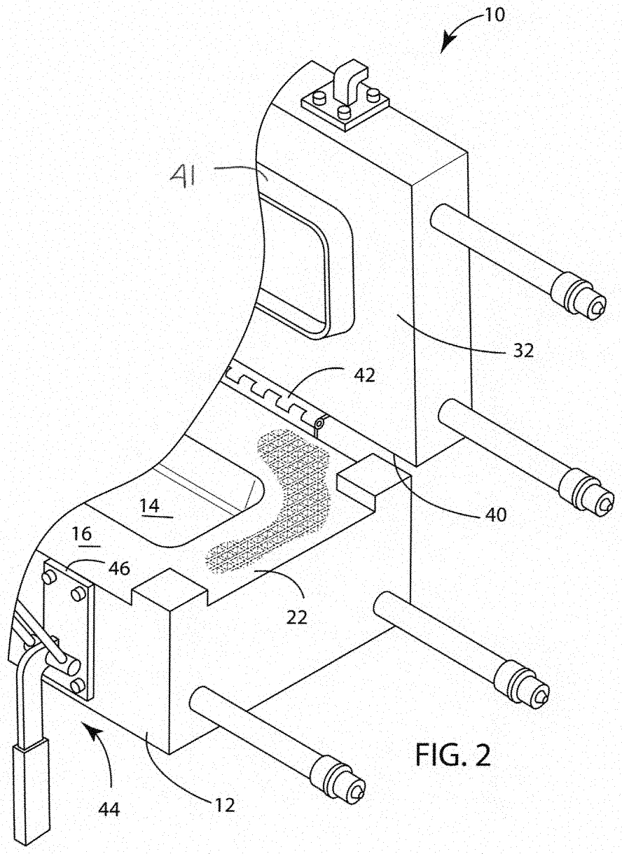

One or more pivot hinges 42 are fixedly secured between the back wall 40 of the upper mold 28 and the back wall 26 of the lower mold 12 for pivotally coupling the upper mold 28 to the lower mold 12 between an open position providing access to the mold cavity 14, as shown in FIGS. 2-4, and a closed position covering the mold cavity 14, as shown in FIG. 1. One or more clamps 44 are operatively coupled between the upper mold 28 and lower mold 12 for clamping the mold tool 10 in the closed position. Each clamp 44 includes a first clamp base 46 fixedly secured to the front wall 24 of the lower mold 12 for pivotally supporting a clamp latch 48 and a second clamp base 50 fixedly secured to the front wall 38 of the upper mold 28 for supporting a clamp lip 52. The clamp latch 48 locking engages with the clamp lip 52 to releasably lock the mold tool 10 in the closed position as shown in FIG. 1 and releases from engagement with the clamp lip 52 to allow the mold tool 10 in the open position as shown in FIGS. 2-4.

Finally, each of the lower mold 12 and upper mold 28 have temperature control units, which in one form include fluid lines 54, 56, respectively, extending therethrough for circulating heated and/or cooled fluid, such as water, through the molds 12, 28 to control the expansion and curing of the liquid polyurethane foam poured into the mold cavity 14 as is commonly known in the art of poured foam. These fluid lines 54, 56 may include respective inlets 54A, 56A and outlets 56A, 56B. It will be understood that the temperature control units may include heating units that may comprise electric heating elements to heat the lower mold 12 and upper mold 28.

The lower mold and upper molds in known mold tool configurations are similar to the lower mold 12 and upper mold 28 but are traditionally formed by casting and machining of metal and then assembling the hinges 42, clamps 44 and fluid lines 54, 56 to complete the mold tool 10. The present invention relates to a method of forming the inventive mold tool 10 utilizing 3D printing and other method steps to form the lower mold 12 and upper mold 28. The method is the same for forming either the lower mold 12 or upper mold 28, therefore, only the method of forming the lower mold 12 will be described further in detail herein relative to the drawings.

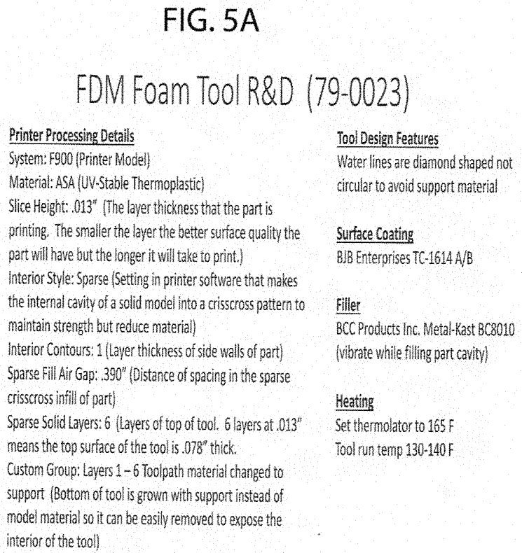

More specifically, the inventive method includes the step of preparing design tool data with best practices for foam tooling and processing the data with specific build parameters for 3D printing. The lower mold 12 may be 3D printed using an ASA, UV-stable thermoplastic material or the like material in a 3D printer such as model F900 by Stratasys Ltd. One example of the 3D printing data and parameters used in the 3d printer is shown in example FIG. 5A for forming a 3D printed lower mold 12 as shown in FIG. 5B. However, it should be appreciated that the data and parameters may vary as desired for the mold tool and foam part to be manufactured.

Referring to FIGS. 2-4, the lower mold 12 is 3D printed to form the top mold surface 16, or A-surface, and the bottom mold surface 18, or B-surface, extending between the side walls 20, 22, front wall 24, and back wall 26. The mold cavity 14 is formed by the 3D printing of thermoplastic material recessed in the top mold surface 16. Similarly, the upper mold 28 is 3D printed to form the bottom mold surface 32, or A-surface, and the top mold surface 30, or B-surface, extending between the side walls 34, 36, front wall 38, and back wall 40. The upper mold 28 includes the mold lid 41, which is formed by the 3D printing of thermoplastic material which projects from the bottom mold surface 32 although it could be recessed as required.

Additionally, the fluid (water) lines 54, 56 within the interior of the lower mold 12 and upper mold 28 are also 3D printed and formed integral or internal to the respective lower mold 12 or upper mold 28. As shown in FIG. 5B, it should be noted that the fluid lines 54, 56 are diamond shaped in cross section, as opposed to circular, when 3D printed as part of the mold tool 10 to reduce the amount of support material needed during the 3D printing to support the opening of the fluid lines 54, 56. The inlets 54A, 56A and outlets 54B, 56B seen in FIG. 1 may also be formed as separate parts mounted to the exterior of the lower mold 12 and upper mold 28.

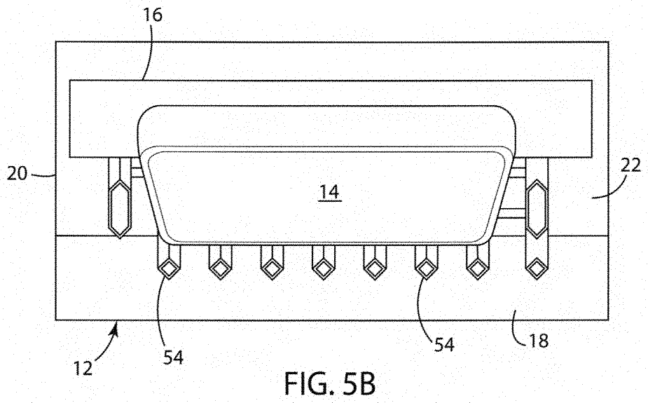

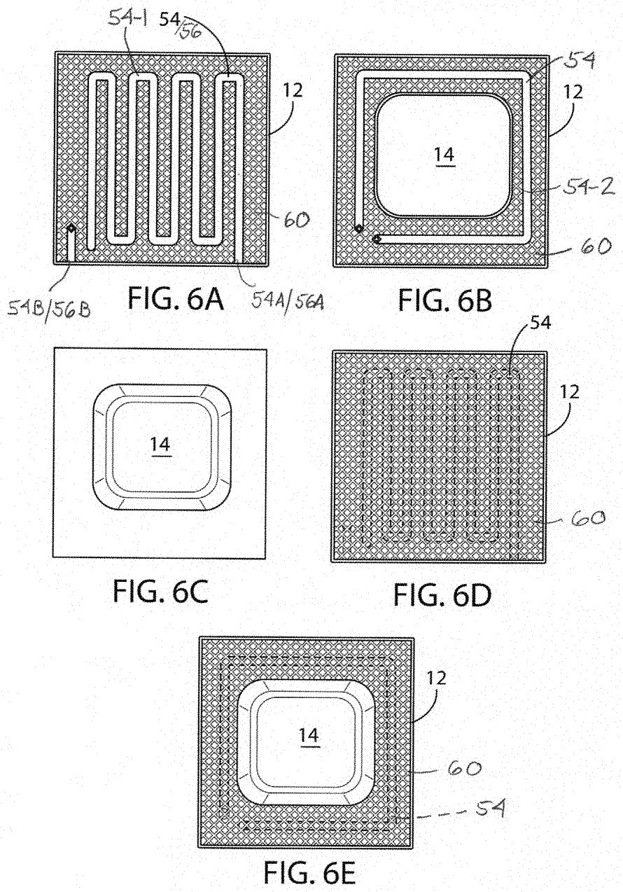

After completion of the 3D printing of the lower mold 12, the lower mold 12 is formed with an interior infill structure 60 that has a porous and open honeycomb type shell as shown in FIGS. 6A-6E and 7A-7E. The infill structure or honeycomb 60 may also be described as being an open, internal lattice structure provided for strength. The upper mold 28 preferably has the same structure.

While these figures illustrate the fluid line 54 formed therein, a similar pattern is provided for the fluid line 56. As seen in FIG. 6A, the fluid line 54/56 may have a serpentine pattern section 54-1/56-1 formed in one level of the infill structure 60, and on a next level of FIG. 6B, a peripheral section 54-2/56-2 joins to opposite ends of the serpentine pattern section 54-1/56-1 and surrounds the mold cavity 14 in the lower mold 12 or surrounds the lid 41 when formed in the upper mold 28. At the top A-surface 16 of FIG. 6C, the infill structure 60 is closed by surface material. FIG. 6D further shows that the infill structure 60 is formed between the serpentine pattern section 54-1 of FIG. 6A and the peripheral section 54-2 of FIG. 6B, and then is formed again above the peripheral section as seen in FIG. 6E. FIGS. 7A-7E show similar views from a side perspective.

The inventive method further may include the step of sanding the top mold surface 18, or A-surface, of the mold 12 if desired to achieve a flat and smooth surface in all critical areas. The upper mold 28 may similarly be sanded on the bottom mold surface 32. Other areas may be sanded as desired such as the mold cavity 14 or lid 41. Next, the method includes the step of brushing, spraying or otherwise applying a coating layer such as a two part epoxy resin onto the top mold surface 18, the side walls 20, 22, the front wall 24 and the back wall 26 to coat, seal and close the porous surfaces thereof and prevent bleeding of any liquid polyurethane or other material therethrough that may be used to fill the infill structure. The surface coating of two part epoxy may be of the type available from BJB Enterprises, Inc. as product number TC-1624 A/B. However, it should be appreciated that other types of surface coatings may be used to seal the surfaces without varying from the scope of the invention.

After the surfaces are sealed, inserts, taps or mounting bolts may be provided for attachment of the hinges 42 and clamps 44 are set in place in the mold tool 10. Additionally, fittings and piping may define the inlets 54A, 56A and outlets 54B, 56B and are provided for connection to the internal fluid lines 54, 56 so as to be attached and set in place in the mold tool 12 and in fluid communication with the internal lines 54, 56. It will be understood that hinges and clamps are provided, alternate mechanisms may be provided for this embodiment and the remaining embodiments to accomplish relative movement between the lower mold and upper mold.

The invention therefore relates to a method of forming a geometric mold component, which in this embodiment defines the lower mold 12 or the upper mold 28. The method also includes the step of applying or pouring a filler of an aluminum filled urethane material into the infill structure and the honeycomb cavities thereof that are exposed in the bottom surface 18, or B-surface, of the lower mold 12 while vibrating the mold 12 to force and evenly distribute the urethane material throughout the mold 12 to fill all of the void space and encapsulate the inserts, taps, bolts and fluid line fittings to the mold 12. As the aluminum filled urethane material hardens, it fills the infill structure and creates a strong bond and solid mold tool 10. Additionally, the aluminum particles in the urethane increases the conductivity and strength of the tool. It should be appreciated that the particles may be other than aluminum, such as copper, magnesium, titanium, or the like which increase the conductivity of the urethane material. An example of a suitable filler is a product manufactured as Metal-Kast BC-8010 by BCC Products Inc. However, it should be appreciated that other filler materials may be used without varying from the scope of the invention.

Once the filler material has hardened, the method includes cutting the bottom mold surface 18, or B-surface, of the lower mold 12 with an NC machine or other suitable cutting device to create a finished, flat and even bottom mold surface 18. The method may further include machining or cutting ribbon vents or attaching autovents into the top mold surface 16, A-surface, to vent gas during the foam pour expansion and molding process as is commonly known in the art.

Once the lower mold 12 and upper mold 28 are formed by the method of the present invention, the upper mold 28 is pivotally attached to the lower mold 12 by the hinges 42. Finally, the mold tool 10 may be connected to a thermolator and set to a desired temperature of, for example, 165 degrees F. with a tool run temperature of 130-140 degrees F. for forming the poured foam part. The mold tool 10 may now be used as is conventionally known to manufacture a poured foam part. For example, liquid polyurethane foam may be poured into the mold cavity 14 with the mold tool 10 in the open position. The mold tool 10 is placed in the closed position with the upper mold 28 covering the mold cavity 14 and lower mold 12. The poured foam expands and cures in the mold cavity 14 for a predetermined amount of time at a set temperature and the mold tool 10 is placed in the open position when complete to provide the finished poured foam part.

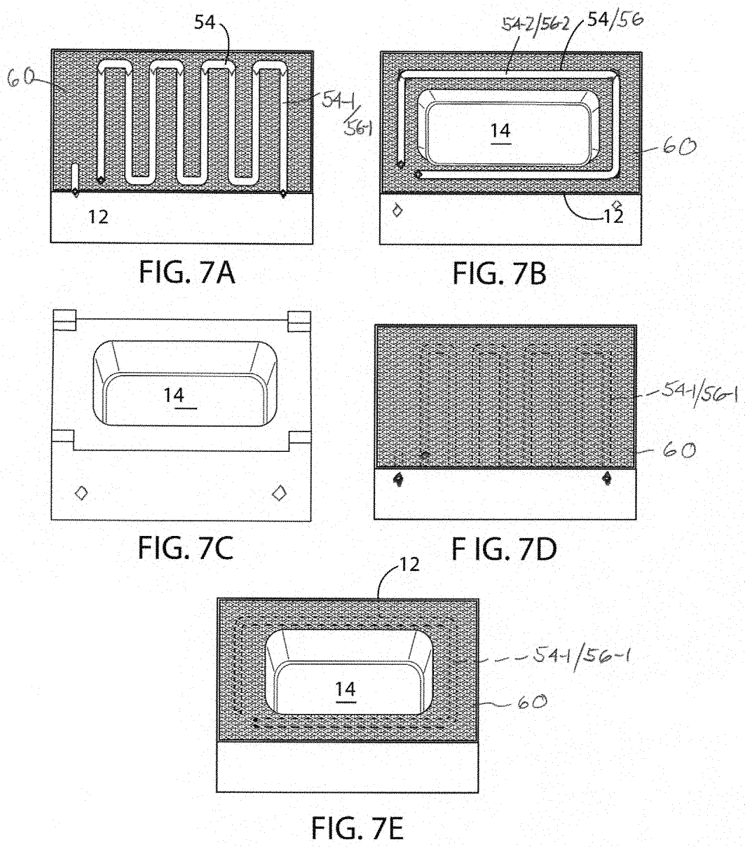

FIG. 8 further illustrates the pattern of the infill structure 60, which is formed as a 3D lattice formed by crisscrossing surfaces which define openings between the surfaces in the shape of a diamond pattern. This pattern fills the interior space of each mold 12 and 28 but also defines openings that form paths extending through the thickness and width of each mold 12 and 28. As such, the flowable filler described above can flow through the body of the molds 12 and 28 and eventually harden so that each mold 12 and 28 is solidified through its width and thickness. As seen in FIG. 8, the 3D printer may also define bolt holes 61 at multiple locations for mounting purposes or the bolt holes 61 may be drilled out of the solidified and filled bodies of the molds 12 and 28.

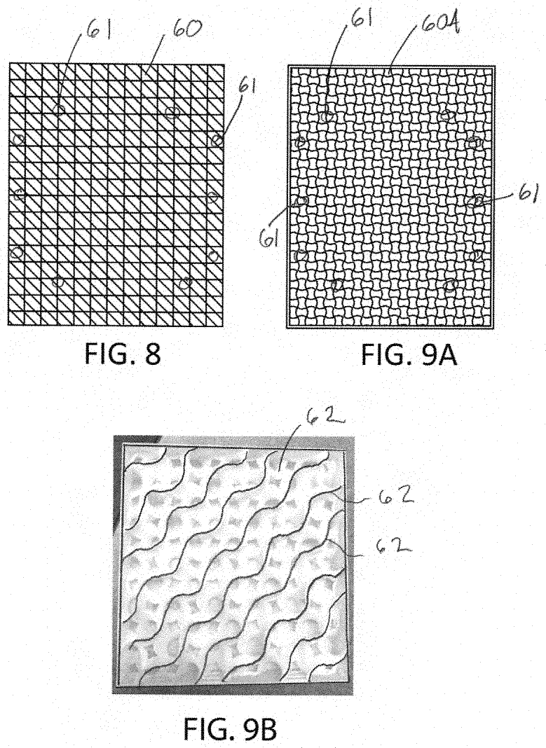

Referring to FIGS. 9A and 9B, an alternate infill structure 60A may have an alternate pattern as shown in FIG. 9A, which has a Gyroid lattice structure. FIG. 9B shows the gyroid infill structure 60A in perspective view. Similarly, the gyroid pattern has crisscrossing side surfaces 62 arranged in a wavy pattern and crisscrossing in multiple layers that define a gyroid honeycomb having openings extending through the thickness and width of each mold 12 and 28. Here again, the infill structure 60A can be filled with the flowable filler described above to solidify the mold bodies.

Referring to FIGS. 9-12, an alternate mold tool 65 is shown, which is constructed by the 3D printing in a manner similar to the above-described molds 12 and 28. The following discussion therefore focuses more on the modifications to the mold tool 65 in comparison to the mold tool 10 with less focus on the common methods for forming the molds using 3D printing.

The mold tool 65 comprises a lower mold 66 defining a mold cavity 67 recessed into a top mold surface 68 forming the A-surface. The mold cavity 67 may be formed as an upward opening bowl for receiving poured foam during the mold operation. The lower mold 66 also includes spaced apart side walls 69, 70 extending between a front wall 71 and a back wall 72 and surrounding the mold cavity 67.

The mold tool 65 further comprises an upper mold 75, or lid, pivotally coupled to the lower mold 66 for closing the mold cavity 67 so that the lower mold 66 and 67 are movable relative to each other. The upper mold 75 similarly includes a bottom surface 76 provided as the A-surface for engaging the opposing top mold surface 68 and closing the mold cavity 67, and includes spaced apart side walls 77, 78 extending between a front wall 79 and back wall 80. A mold lid 81 is formed in the bottom mold surface 76, preferably projecting therefrom, for mating with the mold cavity 67 although the mold lid 81 may also have at least a portion recessed into the bottom mold surface 76.

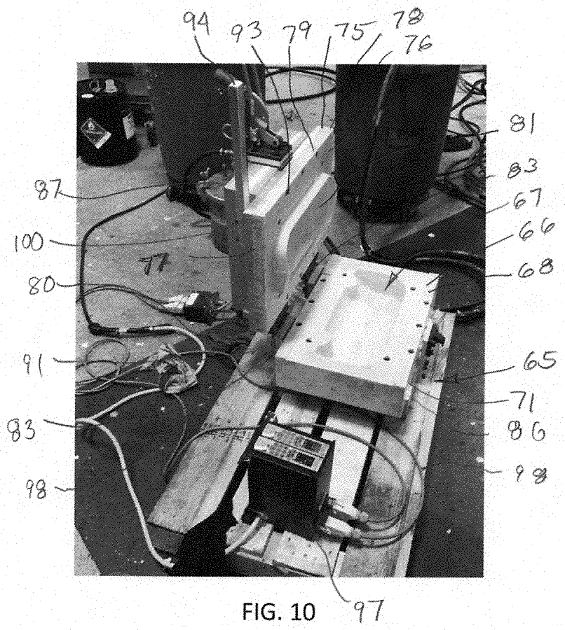

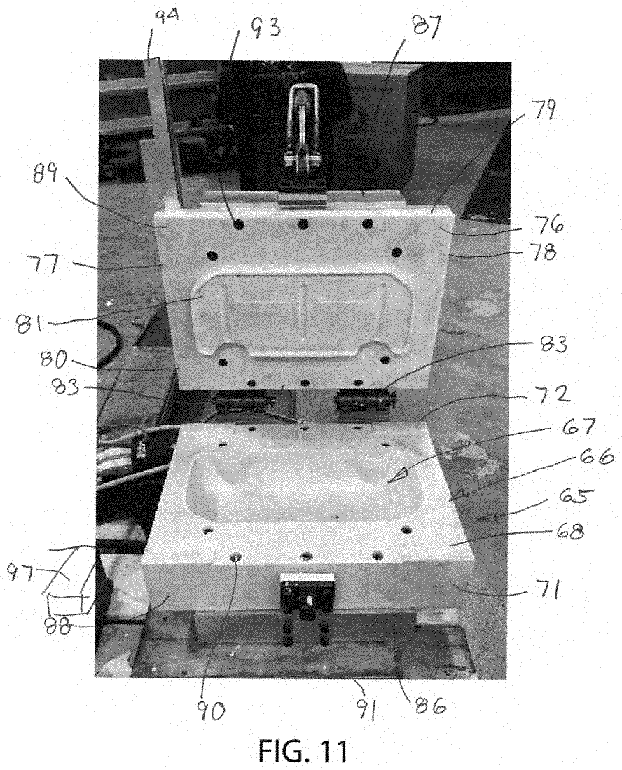

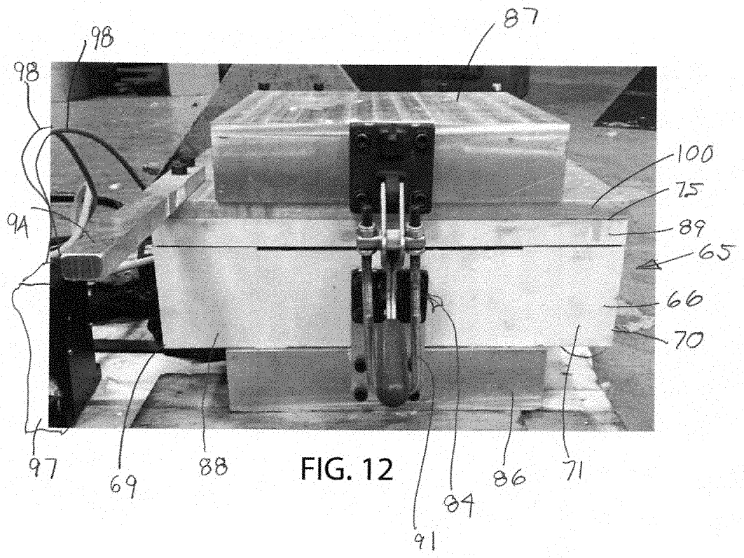

The lower mold 66 and upper mold 75 are pivotally joined by one or more pivot hinges 83 so that the upper mold 75 is pivotable relative to the lower mold 66 to swing between an open position providing access to the mold cavity 67, as shown in FIGS. 10-11, and a closed position covering the mold cavity 67, as shown in FIG. 12. One or more clamps 84 are operatively provided for clamping the mold tool 10 in the closed position.

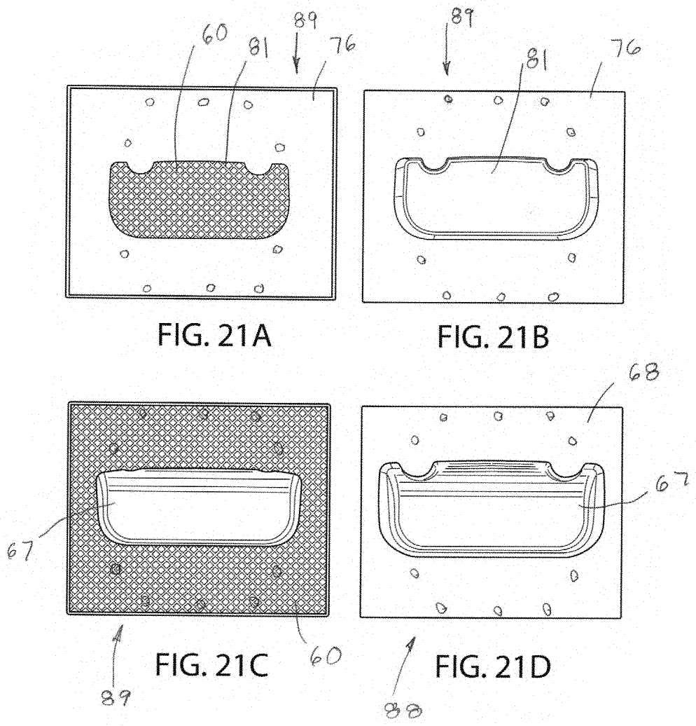

To provide rigid support for the hinges 83 and clamp 84, the lower mold 66 and upper mold 75 comprise rigid, lower and upper main bodies 86 and 87 which are joined with separate the lower and upper mold bodies 88 and 89 that are formed by 3D printing as described above. In more detail, the lower and upper mold bodies 88 and 89 are formed as generally rectangular blocks substantially the same as the lower and upper molds 12 and 28 through 3D printing of the structures and then filling of the honeycomb infill structures 60 as seen in FIGS. 21A-21B (upper mold body 89) and FIGS. 21C-21D (lower mold body 88). These lower and upper mold bodies 88 and 89 are then mounted to the main bodies 86 and 87 as an assembly to thereby form the lower mold 66 and upper mold 75 as described herein.

In more detail, the lower main body 86 may be formed of a rigid material such as aluminum or other metals and is fixed to the lower mold body 88 such as by fasteners 90 extending through the lower mold body 88. Rigid, upstanding support flanges 91 may be provided on the front and back of the lower main body 86 to rigidly support the hinges 83 and clamp 84. As such, the lower mold body 88, which is 3D printed and filled as described, does not carry the loads of the hinges 83 and clamp 84.

Similarly, the upper main body 87 also may be formed of a rigid material such as aluminum or other metals and is fixed to the upper mold body 89 such as by fasteners 93 extending through the upper mold body 89. The upper main body 87 rigidly supports the hinges 83 and clamp 84 and also may support a grab handle 94 for opening and closing thereof. Here again, the upper mold body 89, which is 3D printed and filled as described above, does not carry the loads of the hinges 83 and clamp 84. This construction has one advantage of transferring loads from the 3D printed material to rigid support structure formed of a more rigid material.

This construction also provides additional advantages when heating the molds 66 and 67, particularly where electric heat will be provided. In this configuration, the lower and upper mold bodies 88 and 89 are not printed or formed with internal cooling channels like the above-described channels 54 and 56. Rather, the mold bodies 88 and 89 can be molded in a block similar to FIGS. 8 and 9A-9B so as to include either a diamond pattern infill structure 60 or the gyroid pattern infill structure 60A, and then this infill structure 60 or 60A is filled with a flowable filler such as urethane that then hardens into a solid, rigid block. It will be understood that the term block is not limited to a rectangular or square shape, but other geometric shapes are within the scope of the present invention. As noted, fastener holes 61 may be formed therethrough to receive the fasteners 90 and 93 referenced above so that the lower and upper mold bodies 88 and 89 may be bolted to the lower and upper main bodies 86 and 87.

In this configuration, the lower and upper main bodies 86 and 87 may each have respective temperature control units, which in one form may be internal heating elements extending therethrough, which are controlled by a controller 97 and connected thereto by electrical supply cables 98. Each main body 86 and 87 may have electrical terminals on the back side thereof or any other side which connect to the internal heating elements. Since the main bodies 86 and 87 are formed of metal, heat can be readily conducted to the lower and upper mold bodies 88 and 89 as needed during the formation of molded foam parts. The main bodies 86 and 87 may be formed with a hollow box-like structure having a hollow interior in which the heating elements are placed and then a heat-conductive filler is provided therein to embed and solidify the heating elements in place. This construction allows elimination of fluid filled heating lines, although fluid lines could alternatively be placed in the hollow interior and then embedded in place by a suitable filler.

As such, the main bodies 86 and 87 essentially define heating blocks mountable to the mold bodies 88 and 89. Further the main bodies 86 and 87 provide structural support to the mold bodies 88 and 89. In FIG. 12, it can be seen that the lower main body 86 need not be exactly the same size as the lower mold body 88, although they can be provided in the same size. Alternatively, an intermediate plate may be provided such as backing plate 100, which is shown in FIGS. 10 and 12 sandwiched between the upper main body 87 and the upper mold body 89. The backing plate 100 can provide support to a thinner mold body such as upper mold body 89 or help to distribute heat from a heating block across the back face of the upper mold body 89.

Optionally, the main bodies 86 and 87 may be provided in multiple sizes depending upon the size of the respective mold bodies 88 and 89 being mounted thereto. This would allow different mold bodies 88 or 89, which may have different shapes and designs for the mold cavity 67, to be matched to an appropriately sized main body 86 or 87.

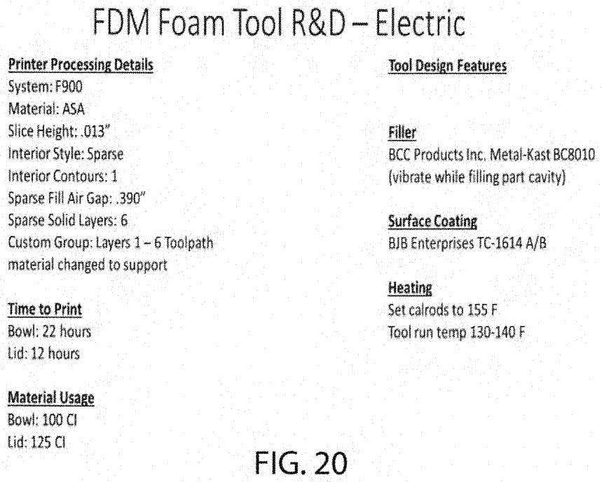

Here again, the mold bodies 88 and 89 may be formed according to the descriptions provided herein. As noted above, the inventive method includes the step of preparing design tool data with best practices for foam tooling and processing the data with specific build parameters for 3D printing. The mold bodies 88 and 89 may be 3D printed using an ASA, UV-stable thermoplastic material or the like material in a 3D printer such as model F900 by Stratasys Ltd. One example of the 3D printing data and parameters used in the 3D printer has been shown in example FIG. 5A for forming a 3D printed mold with the pattern of FIGS. 1-7. Alternatively, the gyroid pattern may be preferred and printed according to the 3D printing data and parameters shown in example FIG. 20. The resultant mold bodies 88 and 89 are further shown in FIGS. 21A-21D. However, it should be appreciated that the data and parameters may vary as desired for the mold tool and foam part to be manufactured.

In accord with the present description, invention further relates to a method of forming a geometric mold component, which in this embodiment defines the lower mold body 88 or the upper mold body 89, wherein the lower and upper mold bodies 88 and 89 may be formed by the steps of: 3D printing the honeycomb mold structure to form an open infill structure such as infill structures 60 or 60A; optionally sanding appropriate mold surfaces as desired; brushing, spraying or otherwise applying a coating layer such as a two part epoxy resin or other sealer onto desired mold surfaces to coat, seal and close the porous surfaces thereof and prevent bleeding of any liquid polyurethane or other material therethrough that may be used to fill the infill structure 60 or 60A; and applying or pouring a filler of, for example, an aluminum filled urethane material into the infill structure and the honeycomb cavities thereof that are exposed while preferably vibrating the mold to force and evenly distribute the filler material throughout the infill structure 60 or 60A to fill all of the void space. As the filler hardens, it fills the infill structure 60 or 60A and creates a strong bond and a solid block. Once the filler material has hardened, the method may include cutting the bottom mold surface with an NC machine or other suitable cutting device to create a finished, flat and even bottom mold surface if desired. The method may further include machining or cutting ribbon vents or attaching autovents into the top mold surfaces, A-surfaces, to vent gas during the foam pour expansion and molding process as is commonly known in the art.

Once the mold bodies 88 and 89 are mounted to the main bodies 86 and 87, the mold tool 65 may now be used as is conventionally known to manufacture a poured foam part. For example, liquid polyurethane foam may be poured into the mold cavity 67 with the mold tool 65 in the open position. The mold tool 65 is placed in the closed position with the upper mold 68 covering the mold cavity 67 and lower mold 66. The poured foam expands and cures in the mold cavity 67 for a predetermined amount of time at a set temperature and the mold tool 65 is placed in the open position when complete to provide the finished poured foam part.

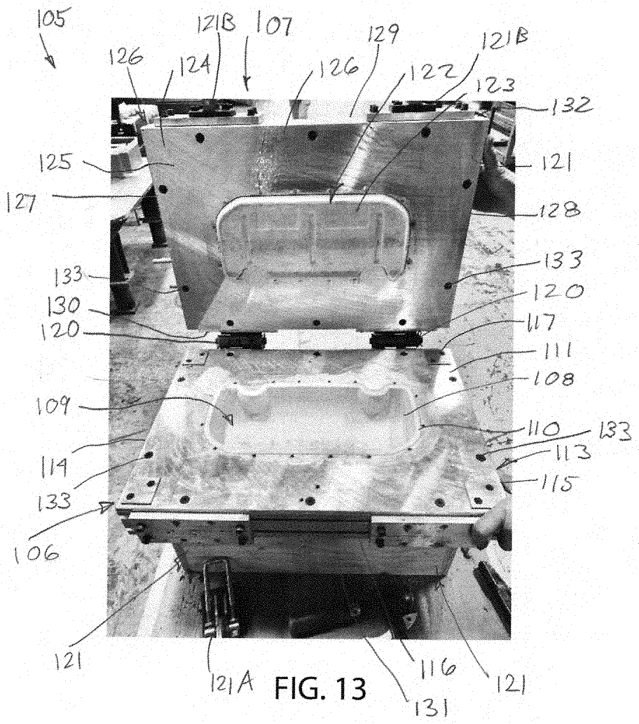

Referring to FIGS. 13-19, a second alternate mold tool 105 is shown, which provides an alternate construction for forming lower and upper molds 106 and 107. The following discussion therefore focuses more on the modifications to the mold tool 105 in comparison to the mold tool 65 with less focus on the common methods used for forming the mold bodies by 3D printing. As discussed below, the lower and upper molds 106 and 107 are formed as mold inserts that inset into corresponding support structure.

The lower mold 106 comprises a separable, 3D printed, lower mold insert 108 that defines a mold cavity 109 recessed into a top mold surface 110. Here again, the mold cavity 109 may be formed as an upward opening bowl for receiving poured foam during the mold operation. The lower mold 106 further includes a lower support panel 111 to which the lower mold insert 108 is mounted. The lower mold 106 also includes a box-like lower main body 113 that defines spaced apart side walls 114, 115 extending between a front wall 116 and a back wall 117 and surrounding the mold cavity 109.

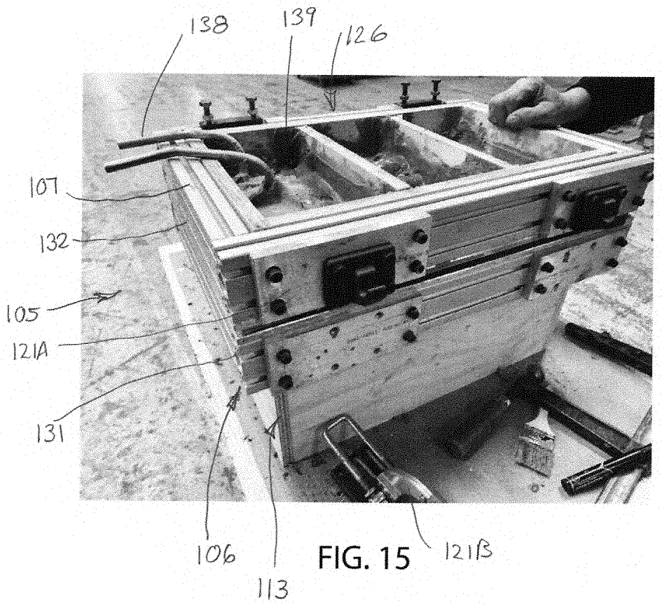

The upper mold 107, or lid, is pivotally coupled to the lower mold 106 by hinges 120 so that the upper mold 107 is pivotable relative to the lower mold 106 to swing between an open position providing access to the mold cavity 109, as shown in FIG. 13, and a closed position covering the mold cavity 109, as shown in FIG. 15. One or more clamps 121 are operatively provided for clamping the mold tool 105 in the closed position, wherein said clamps 121 comprise a clamp latch 121A and clamp lips 121B, and are constructed to operate the same as clamps 44.

The upper mold 107 also includes a separable, 3D printed, upper mold insert 122 that defines a mold lid 123 that preferably projects from a bottom mold surface 124. The bottom mold surface 124 is defined by an upper support panel 125 in which the upper mold insert 122 is mounted. The upper mold 107 also includes a box-like upper main body 126 that defines spaced apart side walls 127, 128 extending between a front wall 129 and a back wall 130 and surrounding the upper mold insert 122. The lower and upper molds 106 and 107 and their respective 3D printed lower and upper mold inserts 108 and 122 are shaped to mate with each other to form molded foam parts in the same manner as the 3D printed lower and upper molds 12 and 28, and the lower and upper molds 66 and 75 described above.

The lower and upper main bodies 113 and 126 may be formed from rigid metal rails that form open box-like lower and upper frames 131 and 132 to provide rigid support for the hinges 120 and clamps 121. The lower and upper main bodies 113 and 126 also support the lower and upper support panels 111 and 125, which are mounted thereto by multiple fasteners 133 secured about the panel peripheries. The support panels 111 and 125 in turn support the lower and upper mold inserts 108 and 122 that are formed by 3D printing using the above-described forming method and mounted to their respective support panels 111 and 126 by multiple fasteners secured about the insert peripheries as described further below.

In more detail, the lower and upper mold inserts 108 and 122 are formed as thinner and smaller structures in comparison to the lower and upper molds described above. The lower and upper mold inserts 108 and 122 are still formed through 3D printing of with infill structures and then filling of the honeycomb infill structures. These lower and upper mold inserts 108 and 122 are then mounted to the lower and upper main bodies 113 and 126 as an assembly to thereby form the lower mold 106 and upper mold 107.

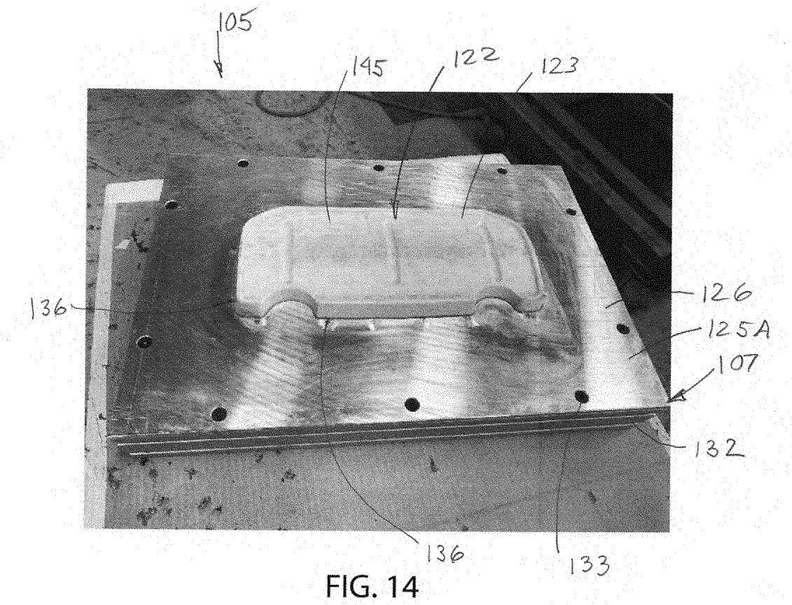

In more detail as to the upper mold 107 shown in FIGS. 14-15, the upper support panel 125 is secured to the upper frame 132 by the fasteners 133 to enclose one side of the upper frame 132. The upper support panel 126 includes a window 136, which opens therethrough and is shaped so that the upper mold insert 122 can project from the back panel side through to the front panel side defined by a panel face 125A. In this configuration, the upper mold insert 122 projects above the panel face 125A for mating with the lower panel insert 108. The upper mold insert 122 includes a peripheral flange fitting against the back side of the upper support panel 126 which is secured in place by fasteners.

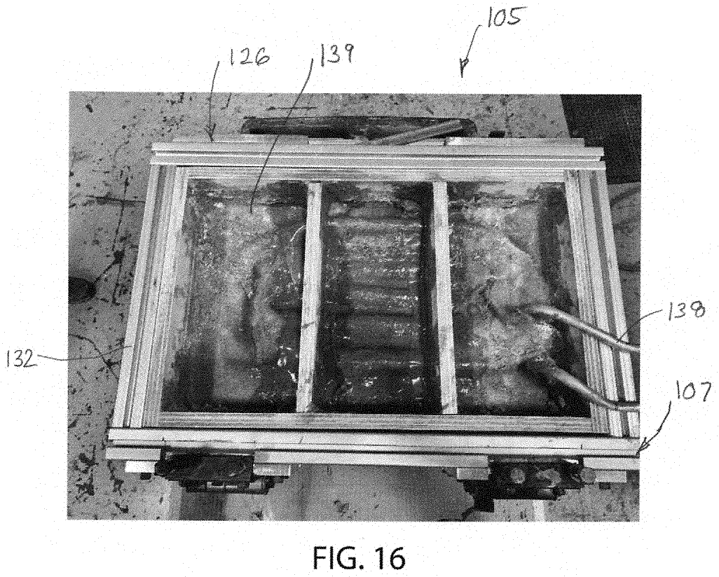

To provide heat to the upper mold 107, the hollow interior of the upper frame 132 is accessible from the top side as seen in FIG. 15, wherein the hollow interior is manufactured with heating units 138 that can be structured as electric heating elements or fluid-circulating heating pipes. The heating unit 138 can be embedded in place by a suitable filler 139 such as a heat-conductive epoxy as seen in FIGS. 15 and 16.

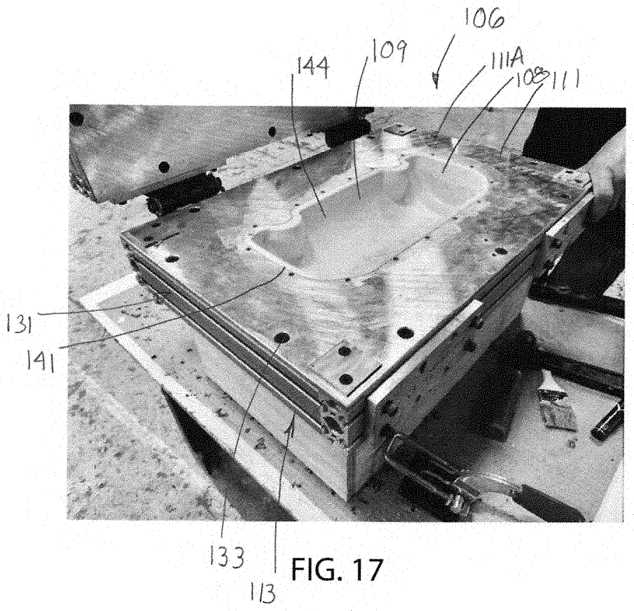

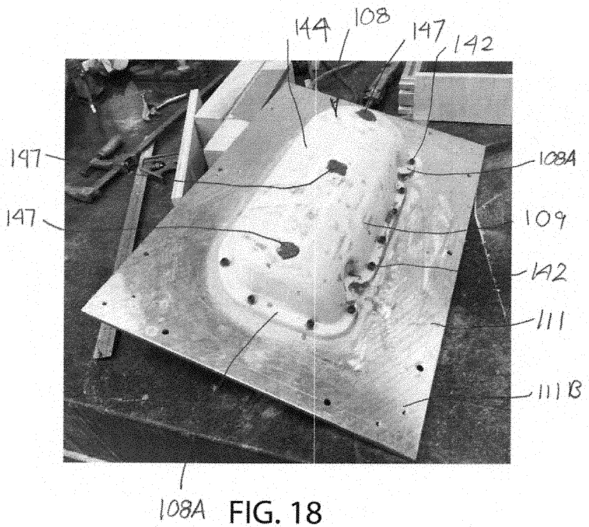

Next as to the lower mold 106 shown in FIGS. 17-19, the lower support panel 111 is secured to the lower frame 131 by the fasteners 133 to enclose one side of the lower frame 131. The lower support panel 111 includes a window 141, which opens therethrough and is shaped so that the lower mold insert 108 can project from the back panel side through to the front panel side defined by a panel face 111A. In this configuration, the lower mold insert 1108 may be flush with or have minimal projection above the panel face 111A for mating with the upper panel insert 1222. As seen in FIG. 18, the lower mold insert 108 includes a peripheral flange 108A fitting against the back panel face 111B of the lower support panel 111 which said flange 108A is secured in place by fasteners 142 spaced about the periphery of the insert 108. The upper mold insert 122 has the same flange construction and mounts to the upper support panel 126 in the same manner.

Here again, this construction has one advantage of transferring loads from the 3D printed material to rigid support structure formed of a more rigid material. Further, the lower and upper support panels 111 and 125 are readily removable and replaceable so that alternate assemblies of support panels and mold inserts may be mounted in place. This provides the flexibility to construct alternate shaped molds for a variety of molded parts, which can then be mounted to modified upper and lower support panels that mount in place in the same manner as lower and upper support panels 111 and 125.

The mold inserts 108 and 122 and flanges are 3D printed using the forming method disclosed above. In a modified form, the lower and upper mold inserts 108 and 122 can be 3D printed with respective lower and upper insert surfaces 144 and 145 that are closed, wherein the entire surface areas of the lower and upper mold inserts 108 and 122 are solid and enclose a generally hollow interior formed with lattice infill structure such as infill structures 60 and 60A. This closed construction can be formed by 3D printing. Preferably on these back sides, the lower and upper insert surfaces 144 and 145 may be generally solid on both the top and bottom such as can be seen relative to the lower mold insert surfaces 144 in FIGS. 17 and 18. However, the insert surfaces 144 and 145 of the lower and upper mold inserts 108 and 122 are exposed on the back side of their respective lower and upper support panels 111 and 125. As such, one or more infill ports can be formed in the insert surfaces 144 and 145. Examples of such infill ports 147 can be seen in FIG. 18 relative to the lower mold insert 108. These infill ports 147 are then injected or filled with the filler described above that flows through the infill structure 60. The filler may be a urethane that then hardens within the infill structure or honeycomb so as to solidify the lower and upper mold inserts 108 and 122.

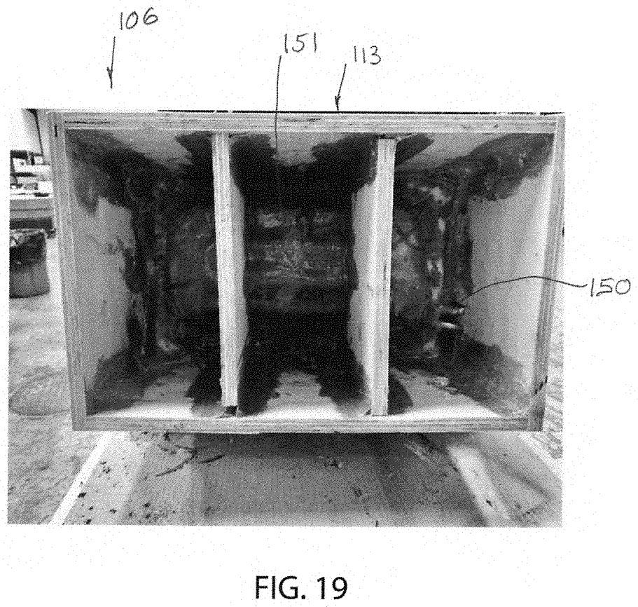

Next, to provide heat to the lower mold 106, the hollow interior of the lower frame 131 is accessible from the bottom side as seen in FIG. 19, wherein the hollow interior is manufactured with heating units 150 that can be structured as electric heating elements or fluid-circulating heating pipes. The heating unit 150 can be embedded in place by a suitable filler 151 such as a heat-conductive epoxy as seen in FIG. 19.

In accord with the present description, invention further relates to a method of forming a geometric mold component, which in this embodiment defines the lower mold insert 108 or the upper mold insert 122, wherein the lower and upper mold inserts 108 and 122 may be formed by the steps of: 3D printing the honeycomb mold structure to form an open infill structure such as infill structures 60 or 60A; optionally sanding appropriate mold surfaces 144 and 145 as desired; brushing, spraying or otherwise applying a two part epoxy resin or other sealer onto desired mold surfaces to coat, seal and close the porous surfaces thereof and prevent bleeding of any liquid polyurethane or other material therethrough that may be used to fill the infill structure 60 or 60A; and applying or pouring a filler of, for example, an aluminum filled urethane material into the infill structure and the honeycomb cavities thereof through the infill ports while preferably vibrating the mold to force and evenly distribute the filler material throughout the infill structure 60 or 60A to fill all of the void space. As the filler hardens, it fills the infill structure 60 or 60A and creates a strong bond and a solid block. The method may further include machining or cutting ribbon vents or attaching autovents into the top mold surfaces, A-surfaces, to vent gas during the foam pour expansion and molding process as is commonly known in the art.

Once the mold inserts 108 and 122 are mounted to the main bodies 113 and 126 by the support panels 111 and 125, the mold tool 105 may now be used as is conventionally known to manufacture a poured foam part. For example, liquid polyurethane foam may be poured into the mold cavity 109 with the mold tool 105 in the open position. The mold tool 105 is placed in the closed position with the upper mold 107 covering the mold cavity 109 and lower mold 106. The poured foam expands and cures in the mold cavity 109 for a predetermined amount of time at a set temperature and the mold tool 105 is placed in the open position when complete to provide the finished poured foam part.

In view of the foregoing, it will be understood that each lid or cavity described above defines a respective geometric shape that imparts a corresponding shape to the part being molded with the respective mold tool 10, 65 or 105.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1. A method for forming a geometric mold component configured for a mold tool having lower and upper molds, wherein said mold component is mountable in the mold tool and has a geometric shape for shaping a molded part in one of the lower and upper molds in the mold tool, said method comprising the steps of:
providing a 3D printer configured to construct said mold component in a geometric shape for shaping molded parts in said molded tool;
3D printing said mold component so as to have an interior infill structure having a honeycomb shape comprising interior openings, and have a solid outer surface surrounding and enclosing at least a portion of said infill structure, said infill structure being joined to and rigidly supporting said outer surface after said 3D printing thereof to provide rigidity to said mold component;
coating said outer surface to provide an outer coating; and
applying a filler into said infill structure and said interior openings, wherein said filler is flowable throughout said infill structure and then hardens to increase the rigidity of said mold component for use in said mold tool.

2. The method according to claim 1, further comprising the step of smoothing said outer surface of said mold component.

3. The method according to claim 2, further comprising the step of sanding said outer surface during said smoothing.

4. The method according to claim 1, further comprising the step of machining any exposed filler.

5. The method according to claim 1, wherein said filler is a hardenable urethane.

6. The method according to claim 1, wherein said coating is an epoxy which seals said outer surface.

7. The method according to claim 1, wherein said infill structure is one of a diamond pattern and a gyroid pattern.

8. The method according to claim 1, further comprising the step of vibrating the mold component during said filling step to force and evenly distribute the filler material throughout the infill structure.

9. A method for forming a geometric mold component configured for a mold tool having lower and upper molds, wherein said mold component is mountable in the mold tool and has a geometric shape for shaping a molded part in one of the lower and upper molds in the mold tool, said method comprising the steps of:
providing a 3D printer configured to construct said mold component in a geometric shape for shaping molded parts in said molded tool;
forming said mold component by 3D printing said mold component in layers so as to have an interior infill structure having a honeycomb shape comprising interior openings, and to have a solid outer surface surrounding and enclosing at least a portion of said infill structure, said infill structure being joined to and rigidly supporting said outer surface after said 3D printing thereof to provide rigidity to said mold component, and at least a portion of said outer surface being formed with a geometric feature which imparts a corresponding shape to the molded part being formed in the mold tool;
coating said outer surface to provide an outer coating, which seals and coats said outer surface; and
applying a filler into said infill structure and said interior openings, wherein said filler is flowable throughout said infill structure and then hardens to increase the rigidity of said mold component for use in said mold tool.

10. The method according to claim 9, wherein said infill structure is one of a diamond pattern and a gyroid pattern which allows said filler to flow across and through an interior of said mold component.

11. The method according to claim 12, further comprising the step of vibrating the mold component during said filling step to force and evenly distribute the filler material throughout the infill structure.

12. The method according to claim 11, further comprising at least one of the steps of:
smoothing said outer surface of said mold component; and
machining any of said filler which may be exposed through said outer surface.

13. The method according to claim 9, further comprising the step of mounting said mold component, after hardening of said filler, into the mold tool for shaping of the molded parts.

14. The method according to claim 13, further comprising the step of mounting said mold component in a main body of a respective one of the lower and upper molds for supporting the mold component in the mold tool.

15. The method according to claim 9, further comprising the step of positioning mold parts at least partially with said mold component after the printing thereof but before the filling thereof, wherein the subsequent filling step and hardening of said filler rigidly joins said mold parts to said mold component.

16. The method according to claim 9, further comprising the step of forming open fluid channels within said infill structure during said 3D printing, wherein said fluid channels remain open after said filling of said infill structure.

17. A mold tool comprising:
an upper mold and a lower mold which are relatively movable between a closed position for molding of molded parts and an open position for removal of molded parts;
at least one of said lower mold and said upper mold comprising a geometric mold component having a geometric feature for imparting a corresponding shape to the molded part being formed by said mold tool;
said mold component having an interior infill structure having a honeycomb shape comprising interior openings, and having a solid outer surface surrounding and enclosing at least a portion of said infill structure;
said interior infill structure and said outer surface being structurally configured by a 3D printer forming said mold component in layers to integrally form said infill structure and said outer surface together, wherein said infill structure is joined to and rigidly supports said outer surface after said 3D printing thereof to provide rigidity to said mold component, at least a portion of said outer surface being formed with said geometric feature;
an outer coating being formed on said outer surface, which seals and coats said outer surface; and
a filler being provided which is flowable to fill said infill structure and said interior openings, and is hardenable within said infill structure to increase the rigidity of said mold component in comparison to said mold component after 3D printing thereof.

18. The mold tool according to claim 17, wherein said mold component is supported on a main body of a respective one of the lower and upper molds for supporting the mold component in the mold tool.

19. The mold tool according to claim 18, wherein one of said mold component and said main body includes a heater unit.

20. The mold tool according to claim 18, wherein said mold component is mounted within a window of a support plate by fasteners, and said support plate is mounted on said main body to define said one of said lower and upper molds.
